(19) United States
(12) Patent Application Publication
(10) Pub. No.: US 2026/0059282 A1
(43) Pub. Date: Feb. 26, 2026

(54) SYSTEMS AND METHODS FOR COMMUNICATIONS OVER NEAR FIELD COMMUNICATION CHANNELS

(71) Applicant: ROYAL BANK OF CANADA, Toronto (CA)

(72) Inventors: Edison U. ORTIZ, Orlando, FL (US); Richard Lee ROBERTSON, Winter Haven, FL (US); Christopher Côté SRINIVASA, Toronto (CA); Arnold BADAL-BADALIAN, Toronto (CA)

(21) Appl. No.: 19/253,436

(22) Filed: Jun. 27, 2025

Related U.S. Application Data
(60) Provisional application No. 63/665,237, filed on Jun. 27, 2024.

(51) Int. Cl. H04W 4/80; G06Q 20/20; G06Q 20/32; H04L 5/14

(52) U.S. Cl. CPC H04W 4/80; G06Q 20/202; G06Q 20/3278; H04L 5/14

(57) ABSTRACT

An improved approach is proposed for adapting available NFC channels to establish a bi-directional NFC channel where no such channel would otherwise be available. The approach is adapted for usage between a mobile device and a target receiver, such as a point of sale (POS) device, both having NFC capabilities. Specific approaches are proposed to orchestrate communications to prevent collisions. The NFC channels can be operated alongside secure elements to establish a dynamic cryptographic handshake that is used for enhancing trust levels for sensitive communications or transactions.

### CROSS REFERENCE

This application is a non provisional of, and claims all benefit including priority from, U.S. Application No. 63/665,237, entitled “SYSTEMS AND METHODS FOR COMMUNICATIONS OVER NEAR FIELD COMMUNICATION CHANNELS”, filed 27 Jun. 2024, incorporated by reference in its entirety.

### FIELD

Embodiments of the present disclosure relate to the field of orchestrating near field communication (NFC), and more specifically, embodiments relate to devices, systems and methods for improved duplex communications over near field communication (NFC) channels by co-operatively operating two open unidirectional channels within the NFC layer for bidirectional data messaging.

### INTRODUCTION

Near field communications are a useful mechanism for communications. However, near field communications protocols can have technical limitations imposed that reduce the communication capability. In particular, these technical limitations can include directionality limitations, where a single exposed NFC channel can only be used to either send or receive, once instantiated between two devices, but cannot be used for sending and receiving in close temporal proximity. Uni-directional communications are not suitable for more complicated interactions, such as handshakes.

The range of NFC can be intentionally limited as a design specification to help limit eavesdropping and also due to the proximity requirement, adduces an additional level of security as the counterparty device must be “physically present”. For example, in a face to face interaction, due to the proximity limitation, a customer has to be physically in front of a cashier to present the customer's mobile device, and thus the cashier is also able to validate visually that the customer is who they purport to be, thus limiting the cybersecurity risk associated with replay, relay, or man-in-the-middle attacks.

Without the ability to send and receive together, there is significant communication latency (e.g., a few hundred ms) between individual data message transfers. As NFC communications are used during short durations of time where the two devices are in sufficient physical proximity (e.g., 4 cm or less) such that the communication can be established, this latency limitation can significantly degrade the communications capability as well as a user experience. The reason for this limitation is that NFC can communicate across inductive coupling across electromagnetic coil elements on each of the two devices, transmitting in different directions at a frequency, for example at 13.56 MHz, at a fairly low data rate (e.g., 100-800 kbits/s).

In an example practical scenario, a user may present a smartphone having NFC capabilities in an NFC antenna residing near the top edge of the smartphone to a counterparty device, such as a verification device, or a point-of-sale device. When the two devices couple together, if there are only simplex communications available, it becomes practically impossible to have complex communications requiring two way communications, such as handshakes, because the user may withdraw the smartphone from the counterparty device and thus not hold the device long enough for the communications to take place over simplex communications where the channel needs to be re-established whenever a communication directionality is required to change. There can also be potential data packet collisions if the communications are not properly controlled. The need for sufficiently fast communications and bi-directional communications is a technical problem that arises due to the technological limitations of un-directional NFC mechanisms.

Other issues with single communication channels are that the range of possible communications protocols, handshakes, and complexity of data payloads and messaging is very limited, and only simple functions are therefore possible. Furthermore, without the ability to engage in these more complex functions, the approach can be vulnerable to various types of cybersecurity attacks, such as replay attacks, relay attacks, man in the middle attacks, among others.

While messages can be conducted via the Internet, for example, using QR codes, without the proximity based nature of NFC, these are easily falsified. For example, a store may provide a QR code in store as an indication that a user is actually in the store during the purchase. However, a user may simply take a picture of a QR code, and reprint for future usage at home, bypassing this security feature entirely. Similarly, a malicious user could also paste a new QR code over the store's QR code and redirect users to a malicious internet page. On the other hand, because of the close proximity of NFC communications, opportunities for relay, replay, snooping, and spoofing cybersecurity attacks are greatly reduced. NFC communications provide a useful mechanism for enhanced trust.

### SUMMARY

Accordingly, digital communications across NFC where the communications are limited, either by hardware restrictions or software restrictions, to simplex directional communications encounter technical problems relating to handshakes and two way communications. Simplex communication channels, where there is only unidirectional transmission with no capability for a receiver to send signals back is thus technically undesirable. These technical limitations impede the flow of communication and due to the technology constraints of NFC, there is a likelihood that the devices will not be in physical proximity long enough to sustain the entirety of the communication.

Example use cases requiring two-way NFC communication include higher security cryptogram-based handshakes between the devices, passing of local sensitive information for authenticating or verifying identity, passing of local sensitive information for coordinating and using loyalty points or loyalty programs, for example. The devices can include two active transmitter devices, or one active NFC device and one passive NFC device. In some embodiments, the first mobile application is configured to control coordinated operation of the first unidirectional NFC communication channel and the second unidirectional NFC communication channel for synchronized transmission of the series of data message payloads. Example pairs of devices being considered, both of which having NFC antennas or communication components, include smartphone to point of sale device communications, smartphone to smartphone communications, and smartphone to computer (having an NFC antenna) communications. The NFC communication being proposed herein is effectively a bonded connection using two separate unidirectional connections that whose communications are orchestrated such that the two devices are able to communicate bi-directionally despite the lack of a formal bi-directional channel being established between the two devices.

An improved approach is proposed for adapting available NFC channels to establish a bi-directional NFC channel configured for half-duplex communications where no such channel would otherwise be available. The approach is adapted for usage between a mobile device and a target receiver, such as a point-of-sale (POS) device, both having NFC capabilities. Both of the devices have mobile applications residing and operating thereon simultaneously, each capable of initiating an NFC channel for directional communications (e.g., the mobile device has an application operating thereon that can push NFC data messages from the mobile device's NFC antenna, and the POS device also has an application operating thereon that can push NFC data messages from the POS device's NFC antenna). The two devices, in an alternate variation, can be two smart phone devices, for example, each having NFC capabilities, or a smart phone device and a laptop having NFC capabilities, according to various embodiments.

As described herein, there can also be variations where the two mobile applications are further in communication across a separate communication channel, such as point to point communications across a network or across a direct connection, such as Bluetooth, or communicating through a wide area network, such as the Internet or an Intranet. In these variations, certain data messages (e.g., cryptogram handshake messages) are passed back and forth using the bonded NFC channels for proximity based communications, while other data messages are passed back and forth using the alternate connection. A benefit of this approach is that the NFC communications can be used to satisfy “physical device present” cybersecurity requirements. This is particularly useful when the payload size is larger, or where there are multiple handshake requirements that need to be conducted through messaging. Furthermore, having a separate communication channel is technically useful for a potential hand-off in situations where the devices are no longer in NFC contact proximity range, and a failover mechanism is triggered.

In the proposed approach, two open channels within an NFC layer (one to send and one to receive information) are used as a mechanism to provide a bidirectional NFC channel to perform data message communications, such as for transactions. The two channels include a first channel and a second channel, the first channel proposed to be accessed on the phone using a mobile application, and the second channel on the POS device using a payment application residing on the POS device. When making a transaction, one channel will send the information to the POS while the other will receive the information back.

The two applications operating on each of the two devices can be open and transmitting. Because the two applications operating their channels independently, as compared to an approach where there is a protocol governing half duplex communications directly from one of the NFC transceivers, in some embodiments, additional synchronization and orchestration/control is required. The two communicating parties may be configured to each have certain communication roles and timing according to a timing orchestration plan or payload that is agreed upon between the parties before transmission. In some embodiments, the timing orchestration plan or payload is established dynamically by one of the two communicating parties prior to the transmission, in other embodiments, the timing orchestration plan or payload is established as part of a communication protocol. In a further embodiment, the timing orchestration plan or payload is established across a separate communication channel whereby the NFC channel communications are used primarily for highly secure cryptogram handshakes, for example, establishing a security level or a physicality presence aspect associated with a data message flow.

For example, the mobile device can have an online banking or payment transaction application that is open and controlling the NFC antenna on the mobile device to transmit unidirectionally to a coupled device. When the NFC antenna couples with a corresponding receiver, it transmits in that direction. The POS device can also have a point of sale/transaction application that is open and controlling the NFC antenna on the POS device to transmit unidirectionally to the mobile device. When the NFC antenna couples with a corresponding receiver, it transmits in that direction.

Essentially, the two channels are established independently by each of the active devices to one another, such that the mobile device can transmit to the POS device across the first channel, and the POS device can transmit to the mobile device across the second channel. The two applications residing on the applications are designed for interoperation and effectively bond the two channels together for duplex communications where communications can effectively occur simultaneously or near simultaneously without the risk of a collision or the need to reserve channels or to switch channel directions for communications. Collisions can be managed (e.g., avoided), for example, through the use of time-division multiplexing, or time reservation mechanisms whereby data payloads are only communicated during reserved timeslots, and the two devices have agreed upon a timeslot orchestration protocol. Another approach for collision management include establishing which device has priority to communicate, for example, by setting logical triggers that can be handed off at each expected communication step as between the two devices.

Given the practical operating environment, in some embodiments, these collision management mechanisms are adapted to take into account re-transmissions and situations where the devices were moved apart from one another and thus out of range for certain communication steps. Collision management can be established through channel reservation protocols that are provided in data payloads that control the operation of the antennas, so that they are operating in a correct mode (transmitting or receiving) during the corresponding periods. In another variation, instead of or in combination with timeslot reservations for specific messages, time-division multiplexing can be used such that specific time allocations are allocated for each device in case that device needs to communicate. An example of such a, time-division multiplexing can included 1 second timeslots carved out by the devices where the device can submit, even out of turn for an ideal protocol, a request for re-transmission, or an error control code, etc.

Because the two NFC uni-directional channels are established independently by mobile application code operating on each device, the orchestration and control aspects are important to avoid collisions (e.g., both devices trying to transmit at the same time).

Both of the devices operate in an active mode and communicate with one another. In some embodiments, the applications on each of the counterparty devices are also communicating across another non-NFC communication channel such as across other communication networks. The non-NFC communication channel can be established either through point to point-communications (e.g., Bluetooth, local area networks), or indirectly (e.g., through wide area network technology or the Internet). By having the non-NFC communication channel, the operation of the two NFC channels can be coordinated and bonded, and used for coordinated communication data messaging that are required in respect of “card present” type emulation.

“Card present” type emulation may require the use of dynamic payloads or cryptograms, whereby a specially configured memory or trusted execution environment (TEE) is provided that maintains an isolated or segregated memory region which holds highly sensitive data objects or encryption keys (e.g., a hardware “wallet”, which can be a segregated processing unit or memory region). During the “card present” type emulation, authentication payloads can be generated (e.g., digitally signed, encrypted) using a combination of the highly sensitive data objects or encryption keys stored thereon and a nonce or time based algorithm, such as a HMAC-based one-time password. The generated signed data object may be valid for a one-time use or for a period of time, or in other embodiments, for a limited number of uses.

By emulating and generating the dynamic payloads or cryptograms for the communications handshake over NFC in conjunction with the data message flow, the devices are able to authenticate or validate that there is a physical hardware “wallet” that is proximate to the two devices. The handshake communications protocol can be time synchronized, establishing a shared secret for generating dynamic payloads/cryptograms, which is transmitted back and forth on the two simplex channels, in accordance with a timing sequence or reservation protocol.

Accordingly, a non-NFC communication channel can be assigned communications for orchestrating an overall transaction flow, such as state changes and transmission of less sensitive information, while the NFC communication across both of the channels in each direction allows for a bidirectional handshake as orchestrated by the non-NFC communication channel. In this example embodiment, there are three channels between the device, with the NFC communication channels operating together as two point to point, limited bandwidth channels that are used for the NFC handshake. The separate network can be used as a failover for the handshake once the main dynamic cryptograms are transmitted, and this is useful in a scenario where devices are pulled away from one another halfway through the handshake. Due to latency and limited bandwidth of the NFC handshake, it is a practical problem where part of the communications can be completed successfully, and the devices are pulled apart before the remaining communication flow is complete. In these scenarios, it is useful for the handshake to have a failover, whereby the most important security payloads are communicated during the initial parts of the handshake.

From an operational perspective, the two applications can be both be open and in a state ready for communications prior to presentment of the NFC device. Communications can be triggered by one of the devices actively engaging the other device by activating the antenna to establish inductive coupling as the devices become in proximity. In another variation, the inductive coupling can be initiated by the devices already being in proximity and relevant mobile applications triggering activation of the NFC antennas. In another variation, the two mobile applications may already be coupled together and communicating across a non-near proximity limited communication mechanism and activate their NFC antennas in accordance with some embodiments described herein for transfer of secure dynamic cryptograms for an additional authentication or verification step.

Once the first device initiates communications, the two devices share a common communication schema that is adapted to avoid collisions. The communication schema is transmitted in the form of a data payload that indicates how timeslots will be managed to avoid collisions, and also to have a level of resilience against potential collisions, the devices being moved apart (e.g., out of range), or failed transmissions by utilizing failovers or re-transmissions. The communication schema data payload also includes timing components that synchronize the clocks for the purposes of the communications as the two on-board clocks may have skew/drift relative to one another.

The proposed approach can be physically implemented in the form of a communication system having two corresponding devices and their corresponding mobile applications that are configured to establish two unidirectional channels for duplex communications by synchronizing and bonding the channels for operation together for bi-directional operation. Both devices operate as initiators and targets at the same time, however, in some variations, the devices operate in a half-duplex manner whereby a communications protocol governs how the two devices message in orchestration, for example, reserving communication timeslots, establishing time synchronization, payload types, payload schemas, etc.

The first unidirectional NFC communication channel and the second unidirectional NFC communication channel can be synchronized through a clock synchronization, and in some embodiments, the clock synchronization occurs through a calibration handshake after initiation of the first unidirectional NFC communication channel and the second unidirectional NFC communication channel. The calibration handshake includes transferring of timestamped test data messages. Clock synchronization can be important for handshakes as handshake messages need to be coordinated and timed to reduce the risk of a cyber attack or a malicious handshake message to be sent by a malicious party. Accordingly, calibration handshake timestamps can be a factor in the validation of whether a handshake message should be accepted or not.

In a practical implementation, the first device is a user's smartphone and the second device is a point of sale device. The user's smartphone and the point of sale device operate in concert to conduct a payment transaction requiring a series of data message payloads to be communicated across the first unidirectional NFC communication channel and the second unidirectional NFC communication channel. The series of data message payloads include additional data payloads corresponding to additional value added services coupled to the payment transaction. The additional value added services can include at least one of a redemption of reward points and usage of existing store credit. An availability of the additional value added services can be communicated using asynchronous message flows from the point of sale device to the user's smartphone, for example based on when a look up operation completes, and a benefit of duplex communications is that there is no need to reserve a channel for this communication. A benefit of using the devices for point of sale uses is that it can be used for a card present emulation mode. In card present emulation mode, dynamically generated cryptogram handshakes must be completed to enhance a trust level of a proposed data message payload. The dynamic generation, as described herein, can include the use of secure cryptographic elements stored on physical secure elements such as segregated, tamper resistant memory having limited interoperation capabilities.

Another variation includes a payment at home scenario whereby the user has two separate devices having NFC communications capabilities, such as a smartphone and a laptop. When buying something on a website and payment details are required, one of the devices may request a NFC communication authentication or authorization from the other device as part of the purchasing flow, for example, where the purchase price is very high. In this scenario, the two devices bond NFC channels together in accordance with some embodiments described herein.

Other variations include using the bidirectional communications for transmitting information back to a sender, such as loyalty information, etc. Further communication flow can be used for redeeming loyalty points. Other variations for a purchase flow can include instant loans, buy-now-pay-layer checkout process injection. Another potential use case can be for NFC handshakes for vehicle/physical device unlocks, hotel room keys, gas station payments, among others.

In a further embodiment, one or both of the mobile applications is controlled to render one or more interactive visualization graphical control elements indicative of a progress of a bi-directional handshake. These one or more interactive visualization graphical control elements can include a progress meter or progress bar that is based on the success of various communication message steps as between the two devices. This is helpful when the number of handshake messages are more than two, as the user may need to hold the device in close (e.g., 4 cm or 1.5 inches) proximity for an extended period of time.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a block schematic of two devices showing a transfer of messages across a set of NFC unidirectional channels that together provide bi-directional communications capabilities, according to an embodiment.

FIG. 2 is an example message flow where the two channels are being used together, according to some embodiments.

FIG. 3 is a block schematic of two devices showing a transfer of messages across a set of NFC unidirectional channels that together provide bi-directional communications capabilities, according to an embodiment.

FIG. 4 is a schematic diagram showing example components involved in a transaction, in accordance with some embodiments.

FIG. 5 is a schematic diagram showing example components involved in a transaction, in accordance with some embodiments.

FIG. 6 is a diagrammatic representation of an example message flow between two devices, for example, device and device.

FIG. 7 is a diagrammatic representation of an example message flow between two devices, for example, device and device.

FIG. 8 is a diagrammatic representation of an example message flow between two devices, for example, device and device.

FIG. 9 is a computer diagram showing an example computing device, according to some embodiments.

### DETAILED DESCRIPTION

An improved approach is proposed for adapting available unidirectional NFC channels to establish a bi-directional NFC channel where no such channel would otherwise be available. The approach is adapted for usage between a mobile device and a target receiver, such as a point of sale (POS) device, both having NFC capabilities.

This approach is particularly useful in scenarios where bi-directional channel NFC capabilities of the devices are limited, either by technical limitations, or through vendor decisions. Accordingly, the device is capable of establishing unidirectional channels with the target receiver. In a naïve approach, the unidirectional channels can be used for simplex communications (e.g., one direction only). However, in this naïve approach, high communications latency occurs due to the undesirable waiting and clearance times, and there can also be potential collisions due to uncoordinated messaging. This limitation can be extremely undesirable to a user experience of a payment transaction, for example, where a user would have to hold the mobile device over the POS for a very long time as the message are alternatively transferred over alternatively reserved channels. Accordingly, an uncoordinated approach would significantly constrain communications, resulting in an extreme reduction in throughput. For more complex communications, such as handshakes, bi-directional communications are required given that each device has to authenticate each other as part of the communication flow. Unidirectional channels by themselves are unsuitable for this purpose.

In the proposed approach, the two unidirectional channels are bonded together for coordinated usage in accordance with a half duplex protocol, whereby a communicating party must reserve the channel before usage to avoid messaging collisions. especially if there is desired a set of messages back and forth between the devices (akin to a “walkie talkie”, where the parties take turn speaking over a same channel). Coordination is required to avoid collisions as both devices cannot transmit at the same time.

Different approaches for coordination and time reservation are proposed. The approach, from a practical perspective, can be used to take advantage of the close proximity nature of NFC communications to enhance a security or trust level associated with a transaction. For example, the NFC communications and the bonded channel can be used to cooperatively generate and communicate dynamically generated cryptograms by invoking functions on corresponding physical secure elements (e.g., segregated memory regions that are on tamper resistant circuits or memory storing keys, seeds, or cryptographic seeds). The dynamically generated cryptograms can be used for various enhanced security data payloads, such as physical card present emulation payloads based on stored cryptographic tokens. The dynamically generated cryptograms can be generated alongside nonces, or specific manufacturing information, timestamps, or identifiers of the NFC antennas to further reduce the viability of tampering and/or relay attacks.

The secure element itself can be provided on physically and electronically segregated tamper resistant circuits whereby the memory chips are both encrypted and not accessible directly by the onboard processor and applications. Rather, the secure element can have limited communication capabilities such that onboard cryptograms or encryption keys can only be interacted with (and not accessed directly) using a very limited set of API functionality. These limited capabilities and interactions can include being limited to responding to specific function calls by generating signatures, validating signatures, encrypting, decrypting, etc., and in some embodiments, the function calls are limited only to function calls relating to the NFC handshake messages. Accordingly, the encrypted data objects stored thereon can only be used for proximity based communications. The encrypted data objects can be pushed onto the secure elements, but once pushed on, they can no longer be accessed directly and can only be interacted with through the corresponding APIs and function calls.

These dynamically generated cryptograms are used in a bi-directional payload handshake process whereby an initiating device first transmits an outbound message to a receiving device across a first NFC channel. The outbound message can include a specific payload generated from a corresponding data object in the initiating device's physical secure element. In some embodiments, the physical secure element is configured to limit interactions only to API interactions relating to NFC message generation. The initial outbound message can also include generation steps based on the manufacturing details (e.g., a unique ID or an address) of the corresponding NFC antenna to be used as an attestation. In some embodiments, the outbound message includes a schema and channel bonding data structure that includes a data payload indicating how the channels should be reserved (trigger-based, time-based, or a combination of both), as well as potential fail-over steps using less secure communication networks. The schema and channel bonding data structure can also include time-synchronizing data fields such that the two devices can agree on the definition of t=0 to account for clock drift. By synchronizing clocks for the purpose of the handshake, the channel bonding can be more accurate and thus take less time between handshake messages given an increased accuracy of channel slot reservations.

The receiving device receives the outbound message on the first channel, and can process it to validate the dynamically generated cryptogram from the initiating device. The receiving device also parses the schema and channel bonding data structure to control how its antenna operates in either a receive or a transmit mode based on the proposed message flow. The receiving device initializes the receiving device's NFC antenna to operate in a transmit mode, and dynamically generates a response payload message that can be based on the original inbound message, and updated based on a corresponding cryptogram stored on the receiving device to complete the handshake. The response payload message is transmitted over this second channel. Once the message is sent, the channel can be released for a further message from the initiating device, or it can be maintained for a further message from the receiving device, depending on the schema and channel bonding data structure. In some embodiments, the schema and channel bonding data structure are sent back to the initiating device to request, confirm, or modify future slot reservations, or to update failover information. The schema and channel bonding data structure are managed and transmitted by the mobile applications, as control functions and data processes are used to control operation of the onboard NFC antennas for each of the devices.

In some embodiments, the NFC handshake is done once to establish an enhanced trust level, and upon establishing the enhanced trust level between the devices, the original initiating device now has a complete data package to be able to authenticate higher trust transactions, even if the further communications are not done on the bonded bidirectional communication channel. For example, the NFC handshake can be used to establish the opening of a “bar tab” where a person is given a time-based authentication to purchase a significant quantity drinks at an establishment for the next 5 hours. The trust level is increased for 5 hours and reduced following the 5 hours through the expiry of the trusted data payload.

In another embodiment, the NFC handshake is used for authenticating a set of downstream messages between the receiving device and the initiating device, such as exchanging loyalty program data objects by having the receiving device further reply with a loyalty program account balance, as well as confirmations of redemptions from the loyalty program account balance. By communicating this information over the bonded channel, due to the close proximity requirement of NFC communications, there is increased trust and decreased risk of packet snooping and third party packet injection (spoofing) relative to other communication mechanisms such as Bluetooth™ or the Internet.

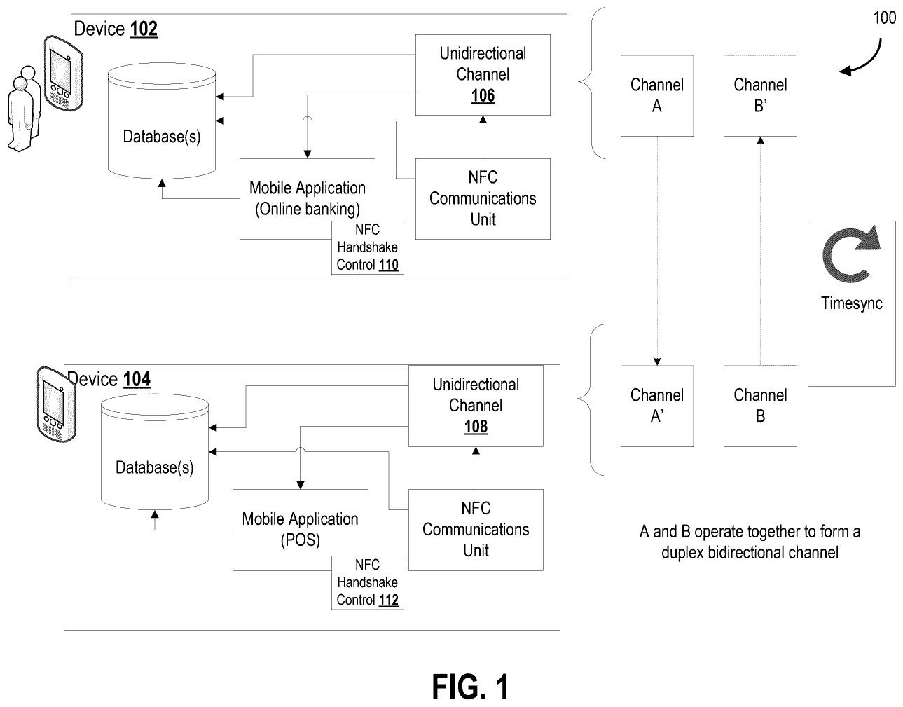

FIG. 1 is a block schematic 100 of two devices 102 and 104 showing a transfer of messages across a set of NFC unidirectional channels that together provide bi-directional communications capabilities. In the block schematic 100, device 102 is a smartphone and device 104 is a POS device (e.g., a POS terminal) though it will be understood that the devices may be other devices equipped with NFC circuits and capable of communicating via NFC technology, including, but not limited to a laptop computer, a desktop computer, a smart lock, and that the devices may be of the same type (e.g., two smartphones).

In the proposed approach, two open channels 106 and 108 within an NFC layer (one to send and one to receive information) are used as a mechanism to provide a bidirectional NFC channel to perform data message communications, such as for transactions. Data message communications can be used for improving transaction security. The two channels include a first channel 106 and a second channel 108, the first channel 106 proposed to be accessed on the phone using a mobile application, and the second channel 108 on the POS device using a payment application residing on the POS device. When making a transaction, one channel will send the information to the POS while the other will receive the information back. Effectively, the first channel 106 can be set up across connections A to A′ on the corresponding devices, and the second channel 108 can be set up across connections B to B′ on the corresponding devices.

The schema and channel bonding data structure are managed and transmitted by the mobile applications, as control functions and data processes are used to control operation of the onboard NFC antennas for each of the devices. Each of the applications include a NFC handshake control module 110, 112, which can be code execution engines configured to control operation of the antennas. Each of the NFC handshake control module 110, 112 can persist its own synchronized clock to each other based on an incoming data payload having clock synchronization information such that the clocks can agree upon a coordinated timeframe.

The mobile application can control the operation of the NFC antenna for different one-way push or receive operation, and toggle the operation of the onboard NFC module between the two modes, receiving data payloads, for example, in the form of NFC Data Exchange Format (NDEF) payloads. As noted herein, even without access to a native bidirectional capability for conducting tasks such as host card emulation, the one-way push or receive operation of an application can be toggled back and forth and controlled in accordance to effectively establish host card emulation capabilities through additional orchestration steps using the bonded connections. Essentially, the NFC handshake control module 110, 112 controls whether the mobile application is operating the physical NFC circuitry in a reader session mode, a writing session mode, and helps encapsulate the messages to be sent across in the writing session mode by controlling the appropriate tag type interface.

As each mobile application on each corresponding device is able to open an NFC channel, both mobile applications operating in concert can effectively establish a bi-directional channel, even if one is not made available or available due to technical limitations. These channels are linked together and coordinated and timed messages can be sent back and forth. The message response/submission and/or timing coordination can be established and cooperatively maintained through an additional communications control schema data payload that can either be sent during the initial communication for the handshake, or sent back and forth with each communication payload to coordinate operations between the two antennas to avoid issues with message collisions.

By orchestrating these messages, two unidirectional channels can be intelligently operated together in coordination, despite not originally being designed to do so. Similarly, failover messaging can be established, which is important when the handshake is interrupted, but potentially the most critical information to establish the trust level were already completed. Where there is a failover situation, other, less secure communication paths can be used with the dynamically generated payloads as the two devices have already mutually authenticated one another.

Once both channels 106 and 108 are open, they can be used for bi-directional communications as one is designated for sending in one direction and the other is designated for sending in the other direction. In this approach, half duplex communications are possible, whereby both parties are able to transmit and receive messages in a coordinated fashion during a time frame, allowing for an improved communication throughput as between the devices. As described further herein, applications for this technology include payment and loyalty transactions, for example, where additional information is provided in each message payload in a series of handshake type messages. Embodiments of this technology can be used for in-store transactions and for at-home transactions (e.g., for verifying large purchases). Other applications include, but are not limited to, security systems such as keyless entry locks (e.g., car lock, hotel door lock, house door lock).

Technical challenges that can occur when two channels are used include ensuring that the operation of the two channels are time synchronized such that timed messages are received and sent in accordance with a proper sequence and not received out of order, and addressing issues where there are capabilities imbalance between the two channels, or one of the channels becomes unavailable or intermittently unavailable. As noted, a failover is possible as well.

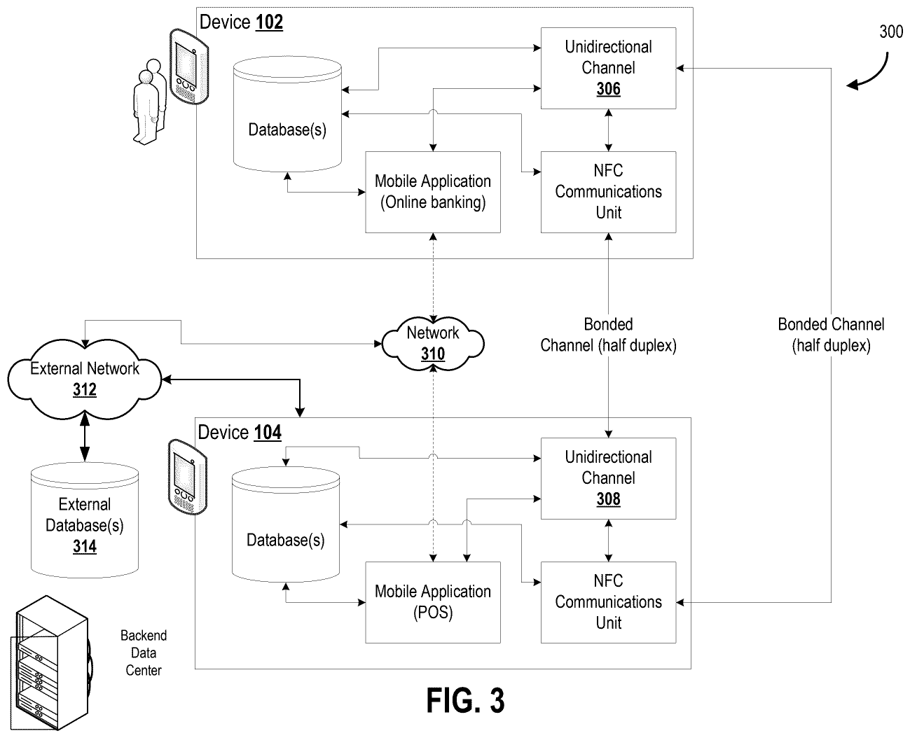

In some embodiments, as shown in the block schematic 300 of FIG. 3, the devices 102, 104 can communicate via a network 310 in addition to communicating via unidirectional channels 306 and 308. Network 310 can be a short-range wireless network, such as Bluetooth, or Wi-Fi or a wide area network, such as a cellular network, the Internet or an Intranet. For example, the devices 102, 104, may transmit and receive messages via network 310 when unidirectional channel 306 and/or 308 is unavailable (e.g., when the devices 102, 104 are no longer in close proximity, when unidirectional channel 306 and/or 308 malfunctions).

As another example, the network 310 may be employed to transmit and receive messages when the messages are large, for example, when the messages are too large to be transmitted as single messages and may require multiple messages to be transmitted, or to conserve NFC resources.

As another example, the devices 102, 104 may employ the unidirectional channels 306, 308 to authenticate devices 102 and/or 104 and subsequently exchange messages via the network 310. The use of network 310 in this example can be advantageous when messages are likely to be transmitted over an extended period of time and keeping the devices 102, 104 in close proximity would be inconvenient or infeasible. For example, the devices 102, 104 may use the unidirectional channels 306, 308 to create a charge account for the device 102 and charges may be applied to the charge account via network 310. Device 102 and/or 104 can determine the length of time for which data can be transmitted via network 310 (e.g., a few minutes, an hour, until the end of the day) and/or the length of time can be predetermined based on the transaction type. For example, data associated with the purchase of a single item may be transmittable via network 310 for a few minutes following the unidirectional channels 306, 308 being opened while data associated with charges applied to a charge account may be transmittable over a longer period of time.

In some embodiments, as shown in block schematic 300, the device 104 can access one or more external database(s) 314 via an external network 312. External database(s) 314 can store associated with additional value-added services (e.g., loyalty/reward point balance, store credit balance) and in some cases, may be maintained by third-party services.

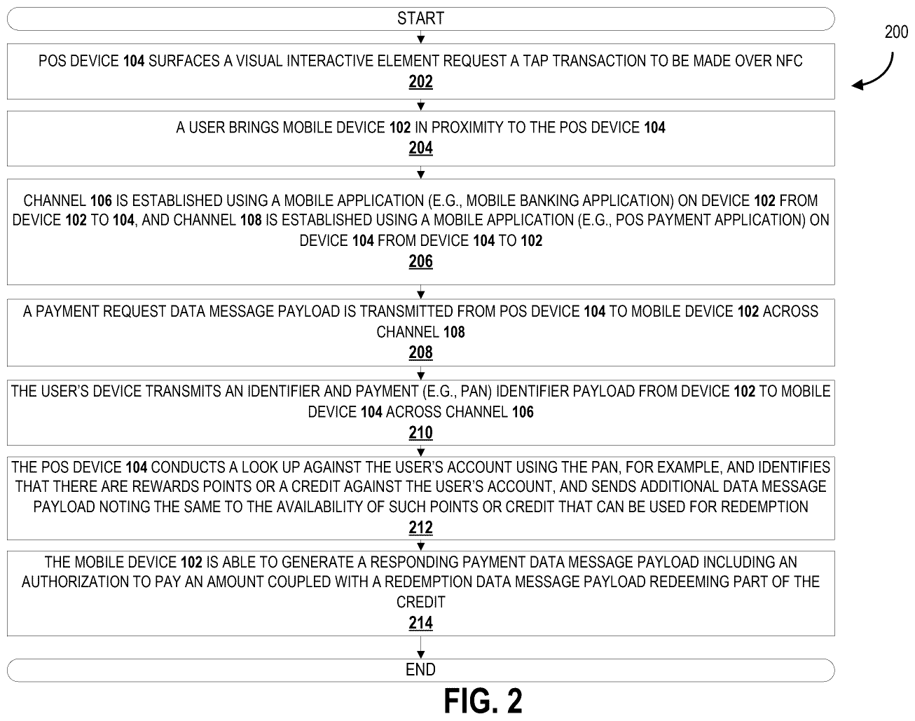

FIG. 2 is an example message flow 200 where the two channels are being used together, according to some embodiments.

In this example, at step 202, the POS device 104 surfaces a visual interactive element requesting a tap transaction to be made over NFC, for example, a payment request.

At step 204, a user brings mobile device 102 in proximity to the POS device 104. The two devices recognize that a transaction is being proposed through proximity sensing of the NFC circuits, and the channels 106 and 108 are established. In this example, at step 206, channel 106 is established using a mobile application (e.g., mobile banking application) on device 102 from device 102 to 104, and channel 108 is established using a mobile application (e.g., POS payment application) on device 104 from device 104 to 102. Each channel is a unidirectional channel, and the channels can be used together.

In some embodiments, an additional step is conducted to synchronize and initialize the two channels for operation together. This may include the sending of test packets and messaging in a handshake or time-synchronization flow to ensure that the two channels are properly configured for interoperation as a combined bi-directional channel for duplex communications.

For example, one of devices 102 and 104 can be configured as an initiator and transmit a message to the other device containing a communication protocol defining rules for exchanging messages between the two devices 102, 104 (e.g., rate of transmission, timing information, message sequence). The communication protocol can be predetermined according to the type(s) of devices and the characteristics of the transaction (e.g., value, type). For example, each type of transaction and/or device may be associated with a specific message sequence. In a first embodiment, the communication protocol and handshake can be pre-arranged as between the devices, and the initiating device simply indicates that it wishes to send messages according to handshake protocol X. In a second embodiment, the communication protocol and handshake are instead sent with either the first message to establish the set of communications (to avoid the technical issue of collisions), or with each subsequent message to “on the fly” conduct future channel reservations for a next one or more messages. The second approach is useful when there isn't a pre-defined number of messages, while the first approach is useful when the two devices are designed for a static communication handshake approach.

For example, if a transaction involves a straightforward loyalty transaction, the first approach may be sufficient. However, if the transaction involves additional message flows, the dynamic channel reservation approach is especially useful. In some embodiments, the communication protocol and handshake messaging schema also include defined re-transmission attempts if a message is not received or a next step is not triggered, as well as potential failover messaging on other network and/or communication media. As described herein, additional timeslots can be reserved for “out of turn” error control or re-transmission messages, which is important given that in practical implementation, the devices will not always be in transmission range, there may be signal interference from external sources, signal interference from obstructions such as thick cases, among others.

A sale for example, can involve the device 102 transmitting a message containing a device identifier and/or user identifier of the user associated with the device 102, the device 104 retrieving the user's loyalty point balance using the device identifier and/or user identifier and transmitting a message to device 102 indicating the user's loyalty point balance, the device 102 transmitting a message indicating whether the user's loyalty points are to be applied to the transaction, and the device 104 transmitting a message indicating the user's updated loyalty point balance.

The initial message from mobile device 102 can include secured payload information from the secure element of the mobile device 102. This secure payload information includes a security nonce and may be configured or cryptographically signed using a data element from a digital wallet cryptogram stored on the secure element of the mobile device 102. The mobile device 102's secure element can be configured for limited interactivity. In some embodiments, the mobile device 102 can use a corresponding security key to sign a proposed transaction, and include attestation information relating to the hardware NFC antenna.

The POS device 104, upon receiving the initial message from mobile device 102 gets ready for the handshake, and can receive a communication protocol as a data payload from the mobile device 102 in addition to the secured transaction message. The communication protocol can establish time windows for each message to be exchanged. The time windows can be of fixed and equal length or can vary depending on the message expected. For example, it may be known that the transmission of a device and/or user identifier requires a time window of t₁=t while transmitting a message indicating the user's loyalty point balance requires a time window of t₂=2t.

In response, the second device can transmit a response message, acknowledging receipt of the communication protocol.

The communication protocol can establish rules to ensure that the two channels 106, 108 can be used simultaneously and that the messages transmitted via the two channels 106, 108 are synchronized. The communication protocol can include means for ensuring the security of the message exchange. For example, the communication protocol can include a cryptographic key. The cryptographic key can be a pre-shared cryptographic key or can be generated by the device transmitting the message containing the communication protocol. In embodiments where the cryptographic key is pre-shared, the device receiving the message containing the communication protocol can verify the cryptographic key prior to acknowledging receipt of the communication protocol.

The communication protocol can establish rules for using the cryptographic key. For example, in some embodiments, the communication protocol can indicate that each message transmitted by the devices 102, 104 is to be signed or encrypted using the cryptographic key. In such embodiments, the devices 102, 104 can authenticate each message received by verifying and validating the cryptographic key or by decrypting the message received. The inclusion of a cryptographic key can enhance transaction security.

In some embodiments, the device transmitting the communication protocol can generate a cryptographic key and cause the cryptographic key to be displayed on the device 104. In such embodiments, the device 104 can request device 102 to transmit the cryptographic key displayed (e.g., by requesting the user associated with device 102 to type in a code displayed on device 104) to authenticate device 102. Requesting device 102 to retransmit the cryptographic key generated by device 104 ensures that device 102 is physically present and that the user associated with device 102 consents to the transaction.

In some embodiments, the two channels 106, 108 are synchronized using timing information. For example, each message transmitted by devices 102 and 104 can include a timestamp and the order of the messages can be determined based on the timestamps. In embodiments where devices 102 and 104 are not clock synchronized, each of device 102 and 104 can, upon receiving an initial message (e.g., test message) from the other device, determine a timing offset, based on the timestamp of the message and the transmission time, and apply a calibration factor to subsequent messages. Time synchronization can include the initiator sending its own clock time at t=0 as part of the initial message. NFC messaging is relatively low latency, and an estimated latency from when the message was sent relative to when it was received can also be accounted for.

After receiving the request, the initiator can compare the initiator's clock time with its own to identify the difference between the two clock times. The initiator's clock time can then be used to establish a common reference time t=0 for the purposes of sending messages back and forth in accordance with the NFC handshakes. The common reference time becomes of increased importance in practical implementation due to the need to manage and avoid collisions.

In some embodiments, the two channels 106, 108 are synchronized using sequence numbers. For example, each message transmitted by devices 102 and 104 can include a sequence number and the order of the messages can be determined based on the sequence numbers.

After transmitting, the counterparty device can await a response. The two devices may have agreed upon a period of time after which no response is received to open up the channel to reserve slots for error message sending or re-transmission that may occur “out of turn”. These slots are pre-arranged to avoid collisions. For example, a device may wait 2.5 s for a response, after which it is given a 0.5 s slot to poll for an update or send a heartbeat. The 0.5 s slot afterwards can be reserved for listening for a re-transmission or error message.

At step 208, a payment request data message payload is transmitted from POS device 104 to mobile device 102 across channel 108. The payment request data message payload can be transmitted subsequent to the channels 106, 108 being synchronized. Alternatively, in some embodiments, the payment request data message can be used to initiate channel synchronization. The POS device 104 can access its own secure element to validate the initial message and/or sign a responsive transaction payload using a securely stored cryptographic key, for example, and can optionally include attestation information and nonce information, such as signatures including antenna hardware manufacturing numbers.

Accordingly at this step, the data payload now has signatures from both devices' secure elements cryptographic keys, and in some embodiments, the signatures are layered upon one another, such that the transaction has been validated by both devices across their NFC handshakes. This data payload can now be used for enhanced trust validation. In some embodiments, the secure element cryptographic keys are used for host card emulation, but other variations are also contemplated.

In some embodiments, the device 104 can display a visual element indicating the progression of the message exchange (e.g., progress bar, percentage, step indicator, hourglass) to assist the user associated with device 102 in determining when the device 102 can be moved away from device 104.

At step 210, the user's device transmits an identifier and payment (e.g., PAN) identifier payload from device 102 to mobile device 104 across channel 106. The identifier can include a transaction identifier, and one or more identifiers identifying the device and/or the user associated with the device 102 (e.g., device identifier, user identifier). This can include the data payload that was signed by both devices as part of the handshake messages, which establishes an enhanced security level for further communications, which in this example is a loyalty card lookup and potential redemption. Other examples are possible, such as establishing a bar tab, for time-duration based authentication, among others.

At step 212, the POS device 104 conducts a look up against the user's account using the PAN, for example, and identifies that there are rewards points or a credit against the user's account, and sends additional data message payload noting the same to the availability of such points or credit that can be used for redemption. For example, the POS device 104 can query a device database or, in some embodiments, an external database 314 via an external network 312.

At step 214, the mobile device 102 is able to generate a responding payment data message payload including an authorization to pay an amount coupled with a redemption data message payload redeeming part of the credit. Accordingly, in this example, the system is able to provide an enhanced value added mechanism through the rapid exchange of messages. The payment authorization can be generated as a result of a real-time payment deducting funds from the user's bank, credit or reward account or can be a token generated by the POS device 104 indicating that the merchant associated with the POS device 104 is authorized to process the transaction at a later time.

As explained, in some embodiments, the devices 102 and 104 can additionally communicate via network 310. In some embodiments, subsequent to the device 104 transmitting the payment request data message payload and the device 102 transmitting the identifier and payment identifier payload, the devices 102 and 104 can be separated and the device 104 can transmit information about value-added services (e.g., loyalty/reward point balance, store credit balance) to device 102 via the network 310. The device 102 can then transmit an authorization to redeem loyalty/reward points or a store credit via the network 310. The use of network 310 can enable the devices 102, 104 to be separated after a short period of time while still allowing the transaction to be authenticated.

By utilizing duplex capabilities instead of simplex communications, this message flow can be practically conducted in a reasonable period of time while the user taps the mobile device 102 on a corresponding portion of the POS device 104. This aids in reducing an overall message latency time and, in some embodiments, allows for additional value to be conducted during an otherwise low bandwidth transaction, such as a payment. The bonding of the connections allows the avoidance of collisions by orchestrating the message flow and operation modes against a synchronized reference clock.

The proximity aspect of NFC communications being used bi-directionally enhances security further as it is practically challenging to snoop/sniff the signals or to have a third party device inject spoofed signals.

As described herein, a proposed variation of the approach uses a hybrid of NFC communications and other less secure communication paths, where the NFC communications are used for the secure handshake, but other communication channels can be used as seamless failover paths once the secure handshake is conducted and the two devices have conducted a mutual authentication in close proximity.

This hybrid approach is useful when the devices need to be authenticated for a longer period of time and it is not practical to keep holding the devices is proximity. The hybrid approach can be practically implemented by setting flags in the communication schema payload indicating which of the data transfer steps necessarily need to be on NFC and which are optional (e.g., nfcOptional=FALSE, nfcOptional=TRUE). If a NFC mandatory step is required for a further step of the communications, in some embodiments, the mobile applications are configured to render or otherwise inject a notification for the user to bring the device back into range for NFC communications, and the two devices re-initiate communications by binding together the two unidirectional communication channels.

While FIG. 2 shows messages being sent from the mobile device 102 to the POS device 104, other variations are possible. Instead, the POS device 104 may be initiating the communication to mobile device 102 instead. In another variation, there are two mobile devices 102 that are communicating with one another instead (e.g., peer to peer data transfer). In another variation, POS device 104 is a laptop and the transaction is occurring in relation to an online purchase that, perhaps has a higher purchase value, and requires a card present emulation to proceed using proximity communications.

As explained above, FIG. 3 is a block schematic 300 of two devices showing a transfer of messages across a set of NFC unidirectional channels that together provide bi-directional communications capabilities, according to an embodiment.

In the block schematic 300, the devices 102, 104 can optionally communicate via a network 310, that can be used for example, as a failover as described in various embodiments herein. Network 310 can be a short-range network (e.g., Bluetooth, Wi-Fi) or a wide area network (point-to-point or multipoint) (e.g., Internet, Intranet, cellular network). The devices 102, 104 may access the network 310 using via a communication interface (not shown) (e.g., antenna(s), communication module), on the devices 102, 104. It is important to note that network 310 may be less secure and more prone to sniffing/spoofing/snooping by third parties.

The network 310 may be used to exchange messages when unidirectional channel 306 and/or 308 is unavailable (e.g., when the devices 102, 104 are no longer in close proximity, when unidirectional channel 306 and/or 308 malfunctions), when the messages exchanged are large and/or to exchange certain types of messages. For example, the devices 102, 104 may employ the unidirectional channels 306, 308 to authenticate devices 102 and/or 104 and subsequently exchange messages via the network 310, allowing the devices 102, 104 to be separated.

In an example embodiment, the devices the devices 102, 104 can employ the unidirectional channels to transmit one or more dynamic cryptograms (e.g., cryptographic key) to authenticate the devices 102, 104.

As another example, the devices 102, 104 may employ the unidirectional channels 306, 308 to transmit sensitive information (e.g., information that has been designated as requiring a high level of security) and exchange messages containing non-sensitive information via the network 310.

In some embodiments, the devices 102, 104 can employ the unidirectional channels 106, 108 to exchange messages and only use network 310 to exchange messages when unidirectional channel 106 and/or 108 malfunctions or fails. In such embodiments, when a channel failure or malfunction is detected by device 102 and/or 104, the devices 102, 104 may use the network 310 if the devices 102, 104 have been authenticated (e.g., have engaged in a handshake at least once).

In some embodiments, access to the network 310 may be granted only upon authentication of the devices 102, 104 via NFC technology. For example, upon device 102 being authenticated, device 104 may transmit, to device 102, information for accessing the network 310.

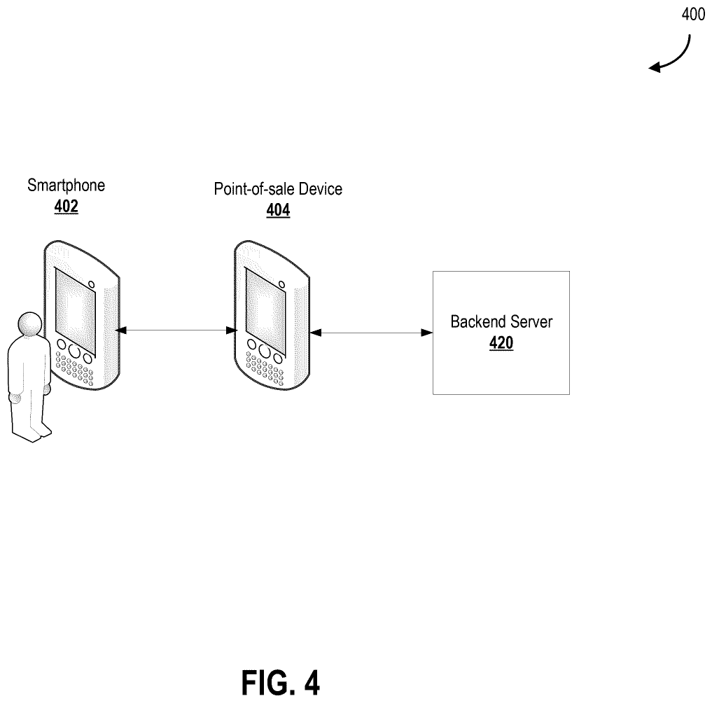

FIG. 4 is a schematic diagram 400 showing example components involved in a transaction, in accordance with some embodiments. As shown, a smartphone 402 associated with a user communicates with a POS device 404. The two devices can communicate over NFC and/or over a network, such as network 310. The POS device 404 is in communication with a backend server 420.

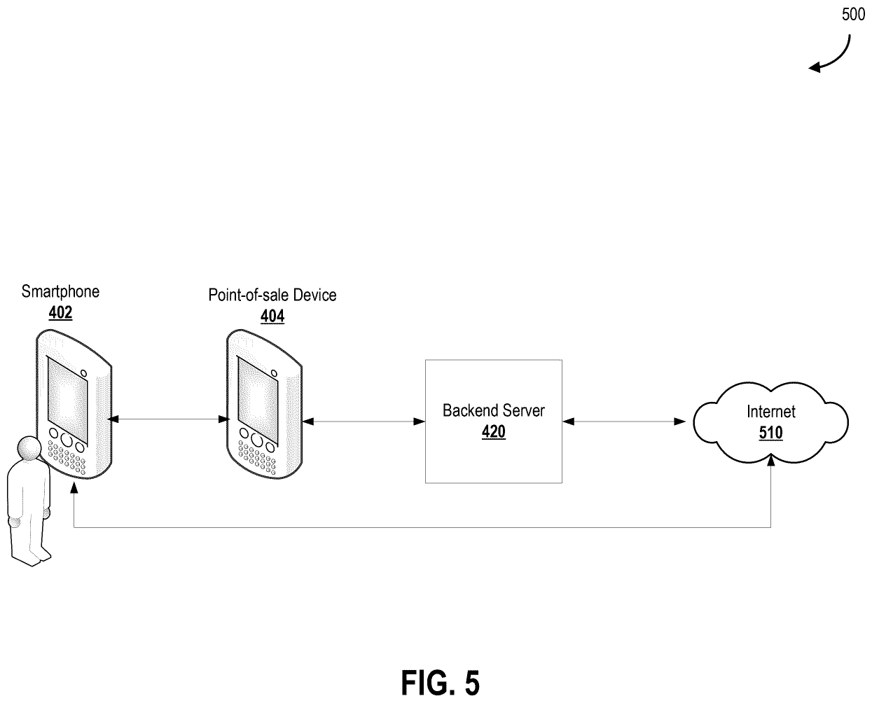

FIG. 5 is a schematic diagram 500 showing example components involved in a transaction, in accordance with some embodiments. As shown, FIG. 5 is substantially similar to FIG. 4. However, the backend server 420 in FIG. 5 can additionally communicate with the internet 510. As shown, the user's smartphone 402 can be in direct communication with the internet 510, for example, the smartphone 402 can receive data retrieved from the internet directly, rather than via the POS device 404.

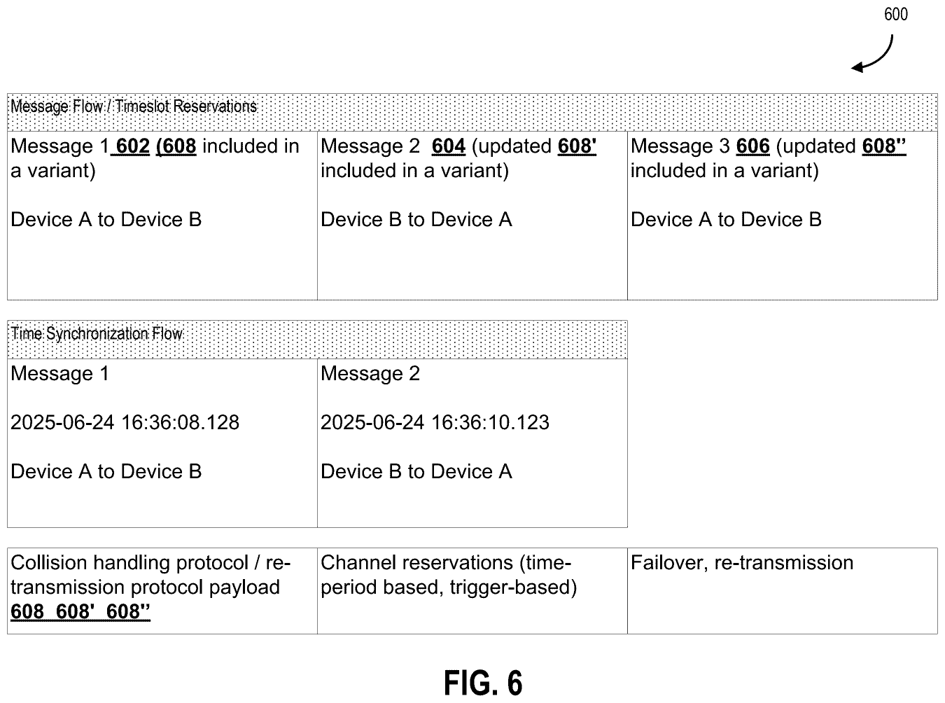

FIG. 6 is a diagrammatic representation of an example message flow 600 between two devices, for example, device 102 and device 104. As shown, during a first time period, a first message 602 can be transmitted between the devices. The initiating message 602, in some embodiments, can further include a specific data payload that is dynamically generated using a secure element from the initiating device that can include, for example, a signed data object signed by the private key of a secure token, and the signed data object can include a physical attestation associated with the NFC Antenna (e.g., Antenna having the unique ID or serial number). By doing so, the initiating message includes information that is used for the handshake for validating the identity and the “presence” of the device that is difficult to falsify. These are used to establish the “shared secret” as part of the handshake.

The secure elements of the devices can store the private keys such that the private keys can be used for authorized, limited type interactions, but the private keys are not directly accessible. The devices can share public keys as part of the handshake, and signed messages. When a response is received, the signature of the counterparty device can be validated against its public key, and if it is overlaid over a signed payload of the originating device using its private key, the combination can now be trusted.

As described herein, the data payloads can be associated with time-based or hardware equipment identifier based nonces or attestations, which can be used to establish either a higher level of security or an automatic time-based expiry. A hardware equipment identifier based nonce ties the module to the physical antenna operating the NFC communications and makes it even more difficult to falsify a physical presence.

In some embodiments, the secure elements are configured with a hard coded specific antenna number and hardware identifier during a device manufacturing process. For example, if the message is received from a non-matching antenna module number, the device may have been tampered with, and the receiving device can simply respond with an error message and refuse the connection. This helps prevent situations where mismatching devices are used in an effort to conduct skimming operations.

A skimmer device may swap out the NFC transceiver antennas with malicious devices designed for information leakage, and this approach may help protect against this type of attack. Similarly, once a handshake is initiated, if the antenna device number changes as between the devices between different messages, this may also be indicative of tampering and the applications can be configured to simply refuse messages or issue an alarm or notification message that sniffing/spoofing may be occurring.

The message sequence can vary, depending on the transaction type, the type(s) of devices and/or the implementation of the present invention. The first message 602 can be transmitted from device 102 to device 104 or vice versa. As explained, the communications protocol can be established during an NFC handshake.

In some embodiments, the message sequence further includes a collision handling protocol data payload 608, which can be either sent initially in the initial message flow, or sent with each message back and forth and updated as 608′, 608″, and so forth. 608, 608′, 608″, etc., are used to reserve and orchestrate channel capacity for each subsequent message flow, indicating when that device expects to receive a next message, and will not transmit during that time so that the channel remains clear. It can be based on absolute time slots, or in some embodiments, relative time slots are used based on triggers. The message payload 608 can include a time synchronization message such that the two devices can sync their clocks to account for differences in clock drift as between their clocks, agreeing upon a common t=0 time relative to their internal clocks.

In further embodiments, payload 608 further includes approaches for assessing and triggering failovers based, for example, an expected quality rating (each device may have X level or dB of signal strength) and proactively move to alternative communications (internet/Wi-Fi/Bluetooth) or turn down speed to communicate at a slower speed/bitrate (e.g., thin vs. thick phone case). The logical conditions can be established within the payload 608 by creating different logical paths for step up/step down communications, as well as failover.

The failovers can be based on if->then logic that is embedded into the data structure, along with loops for re-transmissions and open periods of time for error correction and failover.

As noted herein, certain handshake steps (aside from the core handshake) may be optionally conducted on the NFC channels (if still available), or seamlessly failover to alternate channels once the security handshake steps are completed to establish the level of trust.

As an example, during COVID, restaurants used QR codes per table but used static values (table #47). However, with the proposed embodiments, if NFC capable, the devices are configured instead to also generate a dynamic code transmitted across an NFC handshake. By doing so, malicious users would not be able to randomly order food/drink to a repayable QR code table, as the NFC token/value generated is no longer valid after X period of time no longer table #47 but maybe an encrypted value (ExYSJ1H8d=table #47) at this point in time.

A second message 604 can then transmitted (e.g., from device B to device A), followed by a third message 606 (e.g., from device A to device B). Though the time periods associated with messages 602, 604 and 606 are shown as being of the same length, the length of the time periods can vary, depending on the communications protocol.

Further, though the messages are shown as alternating between device A and device B, the messages need not alternate between the two devices. For example, depending on the communications protocol, consecutive time periods may be allocated to message transmissions from the same device.

In some embodiments, the time periods may be reserved according to the communications protocol such that the periods are of a sufficient length to transmit the messages expected to be transmitted during the time periods. For example, for a sales transaction, it may be determined that each message may take up to X ms to be transmitted and accordingly each time period is assigned a length of X ms.

In other embodiments, the time periods may be reserved but the length of each time period may be determined dynamically. For example, each message may include a “STOP” or “END” of transmission character, indicating to the receiver that the sender has finished transmitting all intended information.

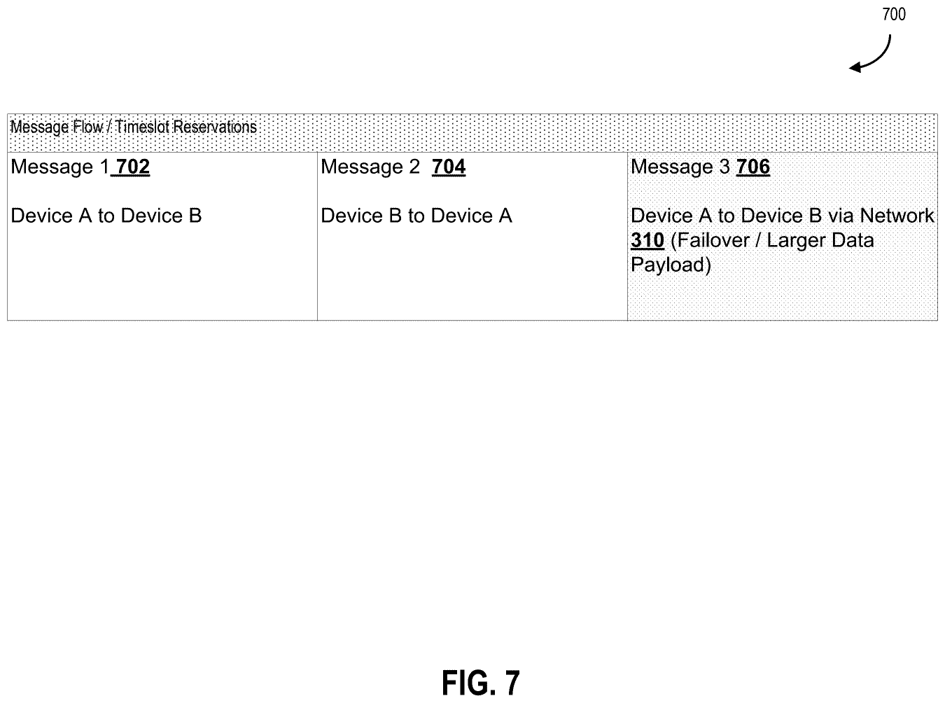

FIG. 7 is a diagrammatic representation of an example message flow 700 between two devices, for example, device 102 and device 104. The transmission of messages 702 and 704 can be substantially similar to the transmission of messages 602, 604 shown in FIG. 6. However, the third message may be transmitted via a network, for example, network 310, rather than over NFC. For example, the third message 706 may be a large message that exceeds the allowable NFC message size and that may require multiple messages to be transmitted. As another example, as explained above, the third message 706 may be transmitted via network 310 due to a channel failure or malfunction.

The initial key pairing can be initiated via the NFC to authenticate & prove proximity and then handed off to a faster network such as Bluetooth™ (to maintain proximity in the bar tab scenario). For faster communications, these communications can also work over Wi-Fi or cellular internet. This can also allow online processing such as tap a terminal (for identification) such as “My device indicates that the user is at Retailer Store #1234 Terminal 3, then conduct an online transaction to be tokenized, pushing that token to a POS terminal and then finish off the transaction”.

This use case is useful in high risk/high fraud transactions (such as gas pump gas purchasing). In another variation, a user may shop online for items (maybe a restaurant) and then push a shopping cart ID via NFC to the POS terminal and pay at the POS (lower fees for merchant as card-present transaction instead of eCommerce transaction). In this example, Table 7 may have ordered 3 coffees in cart #123467.

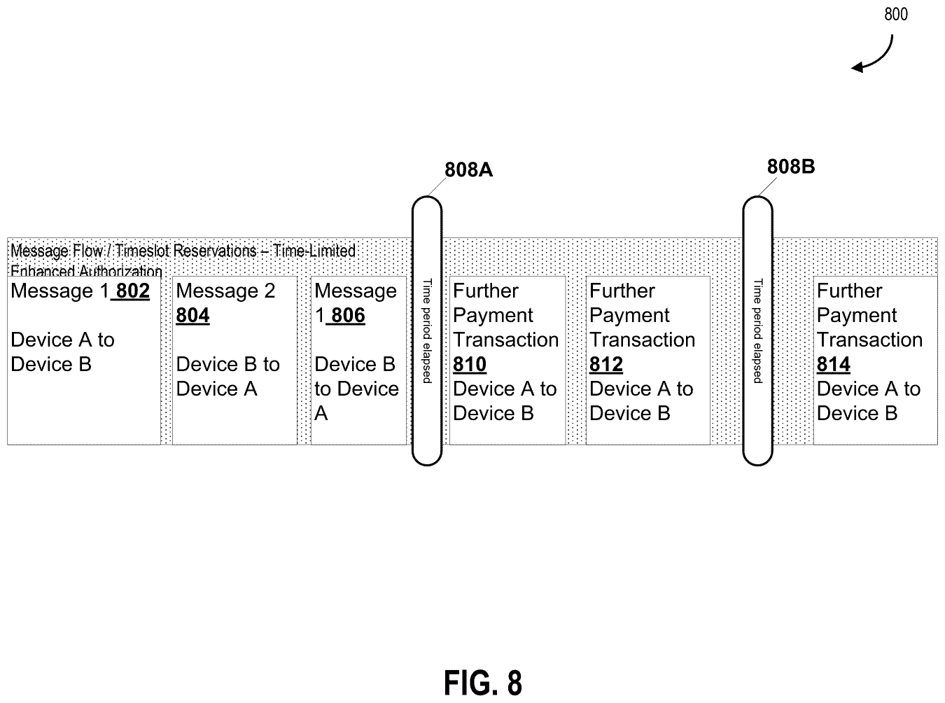

FIG. 8 is a diagrammatic representation of an example message flow 800 between two devices, for example, device 102 and device 104. Message flow 800 may be similar to message flows 600 and 700. However, as shown, message flow 800 may be discontinuous. For example, there may be gaps in time between messages (e.g., message 802 and message 804, between message 804 and message 806).

Further, as shown, there may be extended gaps 808A, 808B in the message flow 800. For example, in some embodiments, the devices may handshake and the handshake may pre-authorize transactions for a pre-determined period of time (e.g., a few minutes, an hour, until the end of the day) without requiring the devices to handshake again. For example, at least some embodiments described herein may be used to open a credit account (e.g., a bar tab) for a user.

To open the credit account, the user's smartphone and the POS device may handshake over NFC, to ensure that the user is physically present. Subsequent transactions (e.g., transactions 810, 812, 814) may be transmitted from the user's smartphone to the POS device without requiring the devices to handshake over NFC. During the initial handshake, a time-limited authorization object may be generated. The time-limited authorization object may establish a length of time for which the devices can exchange messages without requiring a further handshake.

In some embodiments, subsequent transactions can be transmitted via a network, such as network 310.

In some embodiments, the message flow 800 is configured for backwards compatibility. The terminal side will receive, and the device side can finish the initial push with an ask if the terminal can communicate back with it.

In a one way communication from a backwards compatibility perspective, the mobile device transmits to the terminal: Here's a data push, are you capable of 2-way communication? The terminal does not respond to the mobile device. The mobile device terminates the connection.

In a two way communication, in this message flow, the mobile device transmits to terminal: Here's a data push, are you capable of 2-way communication?

The terminal responds with an affirmative message.

The mobile device then initiates the handshake, and sends along a protocol confirmation/channel test message, for example, sending 5 data frames/packets, with a request that after the receiving device receives them, all 5 are confirmed back in order. These messages can include the data payload for the first step of the handshake.

Upon a successful receipt and confirmation, the devices can continue polling to see if there is more information to be transmitted, and coordinate the next steps in the message flow by establishing reservations for the next set of messages, and so on. The devices coordinate by avoiding transmitting on the channel during specific reserved times to avoid a collision.

In a variation where there is two way communication with offloading/resuming:

Mobile device→Terminal: Here's my data push, are you capable of 2-way communication?

Terminal→Mobile device: Yes, I am!

Mobile device→Terminal: Awesome! I'm going to send you 5 data frames/packets, after you receive them, can you confirm back to me you received all 5 in order?

Terminal→Mobile device: I only received 2. Do you have anything else to tell me?

Mobile device→Terminal: Let me resend the 5 again. I'm going to send you 5 more data frames/packets, after you receive them, can you confirm back to me you received all 5 in order?

Terminal→Mobile device: I only received 2. Do you have anything else to tell me?

Mobile device→Terminal: Let me switch to internet/Wi-Fi/Bluetooth and complete this transaction, I'll give you a transaction ID when I am complete. Bye! (terminate connection)

Terminal→Mobile device: (terminate connection)

[ . . . . Transaction is completed online and an encrypted transaction ID is generated]

Mobile device→Terminal: Here's my data push, are you capable of 2-way communication?

Terminal→Mobile device: Yes, I am!

Mobile device→Terminal: Awesome! I'm going to send you 2 data frames/packets (offline transaction ID), after you receive them, can you confirm back to me you received 2 in order?

Terminal→Mobile device: Yes, I received 2 and it appears to be a transaction completed ID. Do you have anything else to tell me?

Mobile device→Terminal: Awesome! I'm all done. Bye! (terminate connection) Terminal→Mobile device: (terminate connection)

In a situation where the 2 way communication begins, but is pulled apart before the completion of the messaging:

Mobile device→terminal: Here's my data push, are you capable of 2-way communication?

Terminal→Mobile device: Yes, I am!

Mobile device→Terminal: Awesome! I'm going to send you 5 data frames/packets, after you receive them, can you confirm back to me you received all 5 in order?

[ . . . pulled apart]

Terminal→Mobile device:

Mobile device→terminal: Terminal→Mobile device: (timeout . . . terminate connection)

Mobile device→terminal: (timeout . . . terminate connection)

[ . . . . Transaction is completed online as a failover and an encrypted transaction ID is generated]

Mobile device→Terminal: Here's my data push, are you capable of 2-way communication?

Terminal→Mobile device: Yes, I am!

Mobile device→Terminal: Awesome! I'm going to send you 2 data frames/packets (offline transaction ID), after you receive them, can you confirm back to me you received 2 in order?

Terminal→Mobile device: Yes, I received 2 and it appears to be a transaction completed ID. Do you have anything else to tell me?

Mobile device→Terminal: Awesome! I'm all done. Bye! (terminate connection) Terminal→Mobile device: (terminate connection)

In the above cases, the device application side determines how much needs to be communicated and divides the frames/packets up to provide a measure of transmission.

For example, a message is 15 frames/packets sized. If the device can send 5 frames/packets at a time it will take 3 transmission sequences (15/5=3) and control mobile application UI lights to be actuated as each transmission is completed successfully.

Initial communication (no lights), first transmission (light up 1 of 3), second transmission (light up 2 of 3), and third/final transmission (light up 3 of 3 lights) and then display “Transmission Complete” message.

If there are more frames/packets to send (such as 100) and the device can send 3 at a time over a fair connection (100/3=33.33) then it will take ˜34 transmissions. From a Ul light perspective, if there is a maximum of 10 lights (due to UI constraints, for example, there can be minimum 3, maximum 10) and after every 3 or 4 transmissions, the device can be configured to render the UI to control lighting up a light and then do a final processing for the stray frames/packets before presenting the “Transmission Complete” message.

As described, additional tasks can add complex functionality requiring multiple responding messages, and these are not limited to value added services or credit/points redemptions, but can also include other communications such as security checks, loan provisioning, among others. For example, a practical embodiment can be usage at a video game arcades. The approach using the secure NFC handshake can be used to save money and space with coin machines and buying physical cards.

Instead, a user uses a mobile phone to purchase value and spend value and store the points obtained from the games (tap to load a “virtual quarter” and then load winning prize points via 2-way communications (or in the background crediting a gamer profile via a mobile app.

This approach helps reduce the propensity and issues associated with lost/abandoned physical cards.

An example bidirectional flow in this example includes:

Player→Arcade: I'm Player #123, here is $0.25 to play Whack a Mole

Arcade→backend: Player 123 won 60 tickets in Whack a Mole.

The approach may also be to casinos or gaming establishment usage to improve upon static barcode/magstripe/NFC based approaches for player tracking, strengthening security and being used to fight fraud.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

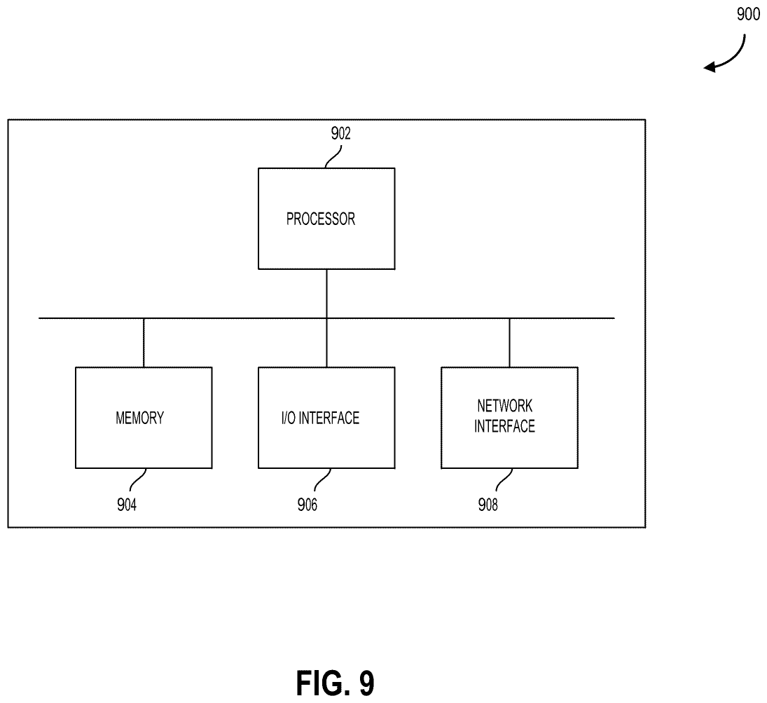

FIG. 9 is a block diagram of a computing device, according to an example embodiment. The computing device 900 may be a mobile device, or a terminal, operating as the initiating device or the receiving device, and includes a processor(s) 902, a memory 904, a network controller 908, and one or more I/O interfaces 906 in communication over a message bus. Processor(s) 902 may be one or more Intel x86, Intel x64, AMD x86-64, PowerPC, ARM processors, or other types of available microprocessors. Memory 904 may include random-access memory, read-only memory, or persistent storage such as a hard disk, a solid-state drive or the like. Read-only memory or persistent storage is a computer-readable medium. In some embodiments, memory 904 is segregated into on-board memory as well as a specific segregated secure memory element having limited API capabilities and limited access capabilities, in some embodiments, where the secure element is only accessing through a limited set of commands and interactions by the processor 902. For example, stored keys may only be used to conduct key signing/decrypting/encrypting/signature validation activities, but they cannot be accessed directly to retrieve the actual key. A computer-readable medium may be organized using a file system, controlled and administered by an operating system governing overall operation of the computing device.

Network controller 908 serves as a communication device to interconnect the computing device with one or more computer networks such as, for example, a local area network (LAN) or the Internet.

One or more I/O interfaces 906 may serve to interconnect the computing device with peripheral devices, such as for example, keyboards, mice, video displays, and the like, and in the embodiments described herein, these include the NFC antennas for the NFC handshake.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended embodiments are intended to include within their scope such processes, machines, manufacture, compositions of matter, means, methods, or steps.

As can be understood, the examples described above and illustrated are intended to be exemplary only.

What is claimed is:

1. A communication system for bi-directional duplex communication between two devices across near field communications channels, the system including:
a first device having a first unidirectional NFC communication channel operable by a first mobile application residing on or operating on the first device;
a second device having a second unidirectional NFC communication channel operable by a second mobile application residing on or operating on the second device;
upon the first device and the second device entering proximity to trigger corresponding NFC antennae, the first mobile application of the first device establishing the first unidirectional NFC communication channel for unidirectional communication to the second device, and second mobile application of the second device establishing the first unidirectional NFC communication channel for unidirectional communication to the first device;
wherein the first unidirectional NFC communication channel and the second unidirectional NFC communication channel are synchronized to provide duplex communication between the first device and the second device.

2. The communication system of claim 1, wherein the first unidirectional NFC communication channel and the second unidirectional NFC communication channel are synchronized through a clock synchronization.

3. The communication system of claim 2, wherein the clock synchronization occurs through a calibration handshake after initiation of the first unidirectional NFC communication channel and the second unidirectional NFC communication channel.

4. The communication system of claim 3, wherein the calibration handshake includes transferring of timestamped test data messages.

5. The communication system of claim 1, wherein the first device is a user's smartphone and the second device is a point of sale device.

6. The communication system of claim 5, wherein the user's smartphone and the point of sale device are operating in concert to conduct a payment transaction requiring a series of data message payloads to be communicated across the first unidirectional NFC communication channel and the second unidirectional NFC communication channel.

7. The communication system of claim 6, wherein the series of data message payloads include additional data payloads corresponding to additional value added services coupled to the payment transaction.

8. The communication system of claim 7, wherein the additional value added services include at least one of a redemption of reward points and usage of existing store credit.

9. The communication system of claim 8, wherein an availability of the additional value added services are communicated using asynchronous message flows from the point of sale device to the user's smartphone.

10. The communication system of claim 9, wherein the first mobile application is configured to control coordinated operation of the first unidirectional NFC communication channel and the second unidirectional NFC communication channel for synchronized transmission of the series of data message payloads.

11. A communication method for bi-directional duplex communication between two devices across near field communications channels operating on a first device having a first unidirectional NFC communication channel operable by a first mobile application residing on or operating on the first device and a second device having a second unidirectional NFC communication channel operable by a second mobile application residing on or operating on the second device; the method comprising:
upon the first device and the second device entering proximity to trigger corresponding NFC antennae, the first mobile application of the first device establishing the first unidirectional NFC communication channel for unidirectional communication to the second device, and second mobile application of the second device establishing the first unidirectional NFC communication channel for unidirectional communication to the first device;
wherein the first unidirectional NFC communication channel and the second unidirectional NFC communication channel are synchronized to provide duplex communication between the first device and the second device.

12. The communication method of claim 11, wherein the first unidirectional NFC communication channel and the second unidirectional NFC communication channel are synchronized through a clock synchronization.

13. The communication method of claim 12, wherein the clock synchronization occurs through a calibration handshake after initiation of the first unidirectional NFC communication channel and the second unidirectional NFC communication channel.

14. The communication method of claim 13, wherein the calibration handshake includes transferring of timestamped test data messages.

15. The communication method of claim 11, wherein the first device is a user's smartphone and the second device is a point of sale device.

16. The communication method of claim 15, wherein the user's smartphone and the point of sale device are operating in concert to conduct a payment transaction requiring a series of data message payloads to be communicated across the first unidirectional NFC communication channel and the second unidirectional NFC communication channel.

17. The communication method of claim 16, wherein the series of data message payloads include additional data payloads corresponding to additional value added services coupled to the payment transaction.

18. The communication method of claim 17, wherein the additional value added services include at least one of a redemption of reward points and usage of existing store credit.

19. The communication method of claim 18, wherein an availability of the additional value added services are communicated using asynchronous message flows from the point of sale device to the user's smartphone.

20. A non-transitory computer readable medium storing machine readable instructions, which when executed by a processor, cause the processor to perform a method communication method for bi-directional duplex communication between two devices across near field communications channels operating on a first device having a first unidirectional NFC communication channel operable by a first mobile application residing on or operating on the first device and a second device having a second unidirectional NFC communication channel operable by a second mobile application residing on or operating on the second device; the method comprising:
upon the first device and the second device entering proximity to trigger corresponding NFC antennae, the first mobile application of the first device establishing the first unidirectional NFC communication channel for unidirectional communication to the second device, and second mobile application of the second device establishing the first unidirectional NFC communication channel for unidirectional communication to the first device;
wherein the first unidirectional NFC communication channel and the second unidirectional NFC communication channel are synchronized to provide duplex communication between the first device and the second device.
